(19) United States
(12) Patent Application Publication
(10) Pub. No.: US 2017/0106512 A1
(43) Pub. Date: Apr. 20, 2017

(54) POP-UP DRAIN FILTER TOOL

(71) Applicant: Leon Joseph Raudys, Minneapolis, MN (US)

(72) Inventor: Leon Joseph Raudys, Minneapolis, MN (US)

(21) Appl. No.: 15/395,026

(22) Filed: Dec. 30, 2016

Related U.S. Application Data
(60) Provisional application No. 62/274,441, filed on Jan. 4, 2016.

(51) Int. Cl. B25B 27/14; E03C 1/23

(52) U.S. Cl. CPC B25B 27/14; E03C 1/23

(57) ABSTRACT

A tool for the removal and reinstallation of drain filters is provided. The tool has a crossbar having a first edge and an opposing second edge. From the first edge a stem perpendicularly extends. From the second edge two spaced apart prongs extend, the distal end of each prong having orthogonal projections for hooking to an underside of the drain filter during its removal. During reinstallation, the stem may pass through a portion of the drain filter so that when the stem is faced downwardly, the drain filter slides down the stem to its appropriate position in a drain assembly.

### CROSS-REFERENCE TO RELATED APPLICATION

This application claims the benefit of priority of U.S. provisional application No. 62/274,441, filed 4 Jan. 2016, the contents of which are herein incorporated by reference.

### BACKGROUND OF THE INVENTION

The present invention relates to drain filters and, more particularly, to a novel tool for the removal and reinstallation of pop-up drain filters.

It's a dirty job to remove or replace the drain filters commonly used in sink and lavatory pop-up drain assemblies. Especially because the drain filter typically sits deep within a drain assembly and so is difficult to remove and reinstall with extant tools. And one cannot readily remove the drain filter from the drain assembly by using only their fingers due to its positioning within the typically small drain. Anyone having such a job would want to perform their task with a single tool that provides a reliable, easily grip so as to prevent the filter or tool from falling into an open drain, wherein that same tool facilitates the reinstallation of the drain filter.

As can be seen, there is a need for a novel tool for the removal and reinstallation of pop-up drain filters.

### SUMMARY OF THE INVENTION

In one aspect of the present invention, a novel tool for removing and reinstalling pop-up drain filters includes a crossbar having a first edge and an opposing second end; a stem perpendicularly extending from the first edge; two spaced apart prongs extending from the second edge away from the stem; and a distal end of each prong providing a transverse projection, wherein the two prongs are spaced apart approximately 17/32 inches, and wherein each prong has a girth of approximately 5/32 inches.

In another aspect of the present invention, a system for removing a pop-up drain filter includes a drain filter having a hollow hub and a plurality of spokes radially extending from the hollow hub; and a tool providing a crossbar having a first edge and an opposing second end; a stem perpendicularly extending from the first edge; two spaced apart prongs extending from the second edge away from the stem, wherein the two prongs are spaced apart and dimensioned to slide between a space defined by adjacent spokes of the plurality of spokes; and a distal end of each prong providing a transverse projection.

In yet another aspect of the present invention, a method for removing and reinstalling a pop-up drain filter having a plurality of spokes by using the novel tool includes sliding the two spaced apart prongs through at least one space defined by adjacent spokes of the plurality of spokes; hooking the transverse projections to an underside of at least one spoke of the plurality of spokes; lifting said pop-up drain filter; sliding said pop-up drain filter down the stem; and inverting the stem so that the pop-up drain filter slides down the stem to a desired location.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a drain filter of the present invention;

FIG. 2 is a perspective view of an exemplary embodiment of a novel tool of the present invention; and

FIG. 3 is a detail perspective view of an exemplary embodiment of the novel tool of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a tool for the removal and reinstallation of drain filters. The tool has a crossbar having a first edge and an opposing second edge. From the first edge a stem perpendicularly extends. From the second edge two spaced apart prongs extend, the distal end of each prong having orthogonal projections for hooking to an underside of the drain filter during its removal. During reinstallation, the stem may pass through a portion of the drain filter so that when the stem is faced downwardly, the drain filter slides down the stem to its appropriate position in a drain assembly.

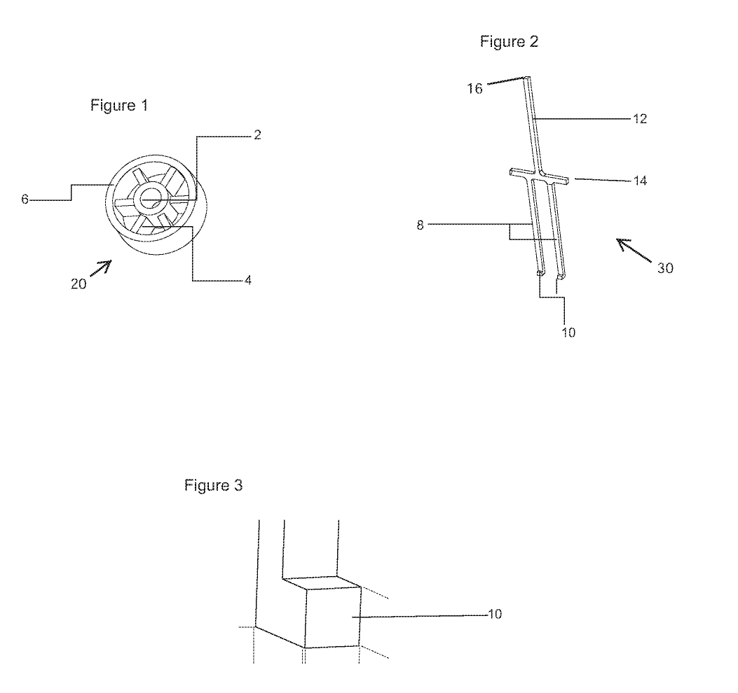

Referring to FIG. 1, the present invention may include a novel tool 30 for the removal and reinstallation of drain filters 20. Typically, the drain filter 20 is round providing an annual hub 2 having a plurality of spaced apart spokes 4 radially extending to a peripheral rim 6. The function of the hollow hub 2 may be to seat or slide the drain filter 20 onto a vertical spindle or screw that is part of the overall pop-up assembly (not shown). The spokes 4 are adapted to catch or filter hair or other unwanted material from clogging the drain. Because of its effectiveness at capturing such hair and material, the drain filter 20 needs to be periodically serviced by removing from the drain assembly and cleaning it. The drain filter 20, unfortunately, typically sits deep within the drain assembly and so is difficult to remove and reinstall with extant tools.

Referring to FIG. 2, the novel tool 30 has a stem 12 perpendicularly joined to a crossbar 14. On an opposing side of the crossbar 14, two spaced apart prongs 8 extend away from the stem 12. The distal end of each prong 8 provides a transversely joined projection 10.

The prongs 8 are dimensioned to be able to be lowered into the drain assembly and pass through the spacing between adjacent spokes 4. Therein, the novel tool 30 can be moved slightly to allow the transverse projections 10 to hook two of the spokes 4 from below. Once the projections 10 have hooked/engaged spokes 4, the drain filter 20 may be lifted out of the drain assembly for services.

Once the drain filter 20 has been serviced, it must be reinstalled. The novel tool 3 facilitates this reinstallation process. The hollow of the annular hub 2 may be threaded by the stem 12 so that the drain filter 20 is urged against the crossbar 14 by way of gravity. Then the novel tool 30 may then be inverted so that the distal end 16 of the stem 12 faces downwardly so as to abut or be adjacent to the vertical spindle or screw of said drain assembly. Then the drain filter 20 may (be released if held against the crossbar 14, say by a user's finger(s)) so as to slide down the stem 12 and onto said vertical spindle or screw—completing the reinstallation process.

The stem 12 may be dimensioned to be smaller than the void/hollow of the annular hub 2 but large enough to provide sufficient surface area to successfully press against the drain assembly spindle or screw. In certain embodiments, the distal end 16 of the stem 12 may be concaved or any other surface feature to successfully allow it to be positioned onto said vertical spindle or screw.

The crossbar 14 is dimensioned to be large/long enough to prevent the novel tool 30 from falling through an open drain.

It should be understood, of course, that the foregoing relates to exemplary embodiments of the invention and that modifications may be made without departing from the spirit and scope of the invention as set forth in the following claims.

What is claimed is:

1. A device, comprising:
a crossbar having a first edge and an opposing second end;
a stem perpendicularly extending from the first edge;
two spaced apart prongs extending from the second edge away from the stem; and
a distal end of each prong providing a transverse projection.

2. The device of claim 1, wherein the two spaced apart prongs are inward of each end of the crossbar.

3. The device of claim 1, further comprising a concave surface along a distal end of the stem.

4. The device of claim 1, wherein the two prongs are spaced apart approximately 17/32 inches, and wherein each prong has a girth of approximately 5/32 inches.

5. A system for removing and reinstalling a drain filter, comprising:
a drain filter comprising:
a hollow hub; and
a plurality of spokes radially extending from the hollow hub; and
a tool comprising:
a crossbar having a first edge and an opposing second end;
a stem perpendicularly extending from the first edge;
two spaced apart prongs extending from the second edge away from the stem, wherein the two prongs are spaced apart and dimensioned to slide between a space defined by adjacent spokes of the plurality of spokes; and
a distal end of each prong providing a transverse projection.

6. The device of claim 5, wherein the two spaced apart prongs are inward of each end of the crossbar.

7. The device of claim 5, further comprising a concave surface along a distal end of the stem.

8. A method for removing and reinstalling a pop-up drain filter having a plurality of spokes by using the device of claim 1, comprising:
sliding the two spaced apart prongs through at least one space defined by adjacent spokes of the plurality of spokes;
hooking the transverse projections to an underside of at least one spoke of the plurality of spokes;
lifting said pop-up drain filter;
sliding said pop-up drain filter down the stem; and
inverting the stem so that the pop-up drain filter slides down the stem to a desired location.
